(19) United States
(12) Patent Application Publication
(10) Pub. No.: US 2013/0259740 A1
(43) Pub. Date: Oct. 3, 2013

(54) SYSTEM FOR TREATING SELENIUM-CONTAINING LIQUID, WET FLUE GAS DESULFURIZATION DEVICE, AND METHOD FOR TREATING SELENIUM-CONTAINING LIQUID

(71) Applicant: CENTRAL RESEARCH INSTITUTE OF ELECTRIC POWER INDUSTRY, (US)

(72) Inventors: Hiroyuki AKIHO, Kanagawa (JP); Hiromitsu MATSUDA, Kanagawa (JP); Shigeo ITO, Kanagawa (JP)

(73) Assignee: CENTRAL RESEARCH INSTITUTE OF ELECTRIC POWER INDUSTRY, Tokyo (JP)

(21) Appl. No.: 13/796,066

(22) Filed: Mar. 12, 2013

(30) Foreign Application Priority Data
Mar. 30, 2012 (JP) 2012-080445

(51) Int. Cl. B01J 19/00

(52) U.S. Cl. CPC B01J 19/00
USPC 422/3; 422/107

(57) ABSTRACT

A system for treating a selenium-containing liquid, a wet flue gas desulfurization device, and a method for treating a selenium-containing liquid treat a selenium-containing liquid by adding bivalent manganese to the selenium-containing liquid, thereby suppressing oxidation of tetravalent selenium to hexavalent selenium. The system includes: a potential measurement unit for measuring an oxidation-reduction potential of the selenium-containing liquid, and a pH measurement unit for measuring a pH value of the selenium-containing liquid; a detection unit for detecting whether or not the selenium-containing liquid is in a state where selenium stabilizes at a valence of 4 or higher, based on the measured oxidation-reduction potential and the measured pH value; and an addition unit for adding bivalent manganese into the selenium-containing liquid when the selenium-containing liquid is in a state where selenium stabilizes at a valence of 4 or higher.

The entire disclosure of Japanese Patent Application No. 2012-080445 filed on Mar. 30, 2012 is expressly incorporated by reference herein.

### TECHNICAL FIELD

This invention relates to a system for treating a selenium-containing liquid, a wet flue gas desulfurization device, and a method for treating a selenium-containing liquid.

### BACKGROUND ART

So far, coal used for coal-fired thermal power generation has generally contained a trace amount of selenium. When the coal is burned in a coal-fired power plant, the selenium in the coal enters coal ash collected by an electrostatic precipitator of flue gas treatment equipment, or enters an absorbing liquid (desulfurization slurry) of a wet flue gas desulfurization device. Under the effluent standards, the standard value of selenium for discharge is set (0.1 mg/L). Thus, the absorbing liquid of the wet flue gas desulfurization device may also have to be treated so as to fulfill the standard value when discharged as effluent after desulfurization.

it is known that at least one element selected from Ti and Mn is added to the selenium-containing liquid to suppress the formation of hexavalent selenium (see, for example, Patent Document 1)

### PRIOR ART DOCUMENTS

### Patent Documents

[Patent Document 1] JP-A-2009-160568

### SUMMARY OF THE INVENTION

### Problems to be Solved by the Invention

According to the method for treating a selenium-containing liquid which is described in Patent Document 1, the selenium-containing liquid can be treated without a high cost. However, there has been a case where even when bivalent manganese is added, the oxidation of tetravalent selenium (selenite ions: SeO₃²⁻) in the selenium-containing liquid to hexavalent selenium (selenate ions: SeO²⁻) cannot be suppressed. Even when bivalent manganese is not added, the state of tetravalent selenium may be retainable without oxidation of selenium. In this case, the addition of bivalent manganese is not preferred.

Under these circumstances, the present invention aims at solving the problems of the conventional technologies mentioned above. It is an object of this invention to provide a system for treating a selenium-containing liquid, a wet flue gas desulfurization device, and a method for treating a selenium-containing liquid, which can suppress the oxidation of tetravalent selenium in a selenium-containing liquid more appropriately.

### Means for Solving the Problems

The system for treating a selenium-containing liquid according to the present invention is a system for treating a selenium-containing liquid by adding bivalent manganese to the selenium-containing liquid, thereby suppressing oxidation of tetravalent selenium to hexavalent selenium, comprising: potential measurement means for measuring an oxidation-reduction potential of the selenium-containing liquid, and pH measurement means for measuring a pH value of the selenium-containing liquid; detection means for detecting whether or not the selenium-containing liquid is in a state where selenium stabilizes at a valence of 4 or higher, based on the measured oxidation-reduction potential and the measured pH value; and addition means for adding bivalent manganese into the selenium-containing liquid when the selenium-containing liquid is in a state where selenium stabilizes at a valence of 4 or higher.

in the present invention, whether or not the selenium-containing liquid is in a state where selenium stabilizes at a valence of 4 or higher is detected by the detection means based on the measured oxidation-reduction potential and the measured pH value. When the selenium-containing liquid is in a state in which selenium is stable at a valence of 4 or higher, bivalent manganese is added into the selenium-containing liquid. In this manner, only when tetravalent selenium is likely to be oxidized to hexavalent selenium, bivalent manganese is added to suppress the oxidation of selenium. According to this procedure, the oxidation of tetravalent selenium in the selenium-containing liquid can be suppressed more accurately.

Preferably, when detecting that the selenium-containing liquid is in a state where selenium stabilizes at a valence of 4 or higher, based on the measured oxidation-reduction potential and the measured pH value, the detection means detects whether or not the selenium-containing liquid is in a state where manganese stabilizes as manganese dioxide, based on the measured oxidation-reduction potential and the measured pH value. Also preferably, the system for treating a selenium-containing liquid further comprises lowering means which, when the selenium-containing liquid is in a state where manganese stabilizes as manganese dioxide, lowers the oxidation-reduction potential of the selenium-containing liquid until the selenium-containing liquid falls into a state where manganese stabilizes as bivalent manganese. By lowering the oxidation-reduction potential until the selenium-containing liquid falls into a state where manganese stabilizes as bivalent manganese, the oxidation of selenium can be suppressed appropriately, with the amount of consumption of bivalent manganese being kept down, when bivalent manganese is added.

in a preferred embodiment of the present invention, the additions means includes first concentration measurement means for measuring a concentration of peroxodisulfuric acid in the selenium-containing liquid; second concentration measurement means for measuring a concentration of tetravalent selenium in the selenium-containing liquid; and setting means for setting a predetermined bivalent manganese concentration based on the concentration of peroxodisulfuric acid and the concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid, and the addition means adds bivalent manganese into the selenium-containing liquid such that the selenium-containing liquid has the predetermined bivalent manganese concentration.

Preferably, when detecting that the selenium-containing liquid is in a state where selenium stabilizes at a valence of 4 or higher, the detection means detects whether or not the selenium-containing liquid is in a state where manganese stabilizes as manganese dioxide, based on the measured oxidation-reduction potential and the measured pH value, and when the selenium-containing liquid is in a state where manganese stabilizes as manganese dioxide, the setting means sets a higher bivalent manganese concentration than the predetermined bivalent manganese concentration. When the selenium-containing liquid is in a state where manganese stabilizes as manganese dioxide, manganese tends to be converted into manganese dioxide by oxidation not only upon reaction with peroxodisulfuric acid, but also upon reaction with an oxidizing substance other than peroxodisulfuric acid (e.g., dissolved oxygen in the selenium-containing liquid, various metal components, etc.). Thus, even when bivalent manganese is added such that the predetermined bivalent manganese concentration is achieved, there tends to be a deficiency in bivalent manganese, and the oxidation of tetravalent selenium may be impossible to suppress. Hence, the setting means sets the bivalent manganese concentration to be higher than the predetermined bivalent manganese concentration. By so doing, bivalent manganese can be added in a larger amount than oxidized with peroxodisulfuric acid. As a result, even in a case where bivalent manganese is oxidized by reaction with an oxidizing substance other than peroxodisulfuric acid, the unreacted remaining bivalent manganese can suppress the oxidation of tetravalent selenium.

The wet flue gas desulfurization device of the present invention is a wet flue gas desulfurization device for removing sulfur oxides in an exhaust gas, comprising: potential measurement means for measuring an oxidation-reduction potential of a selenium-containing liquid, and pH measurement means for measuring a pH value of the selenium-containing liquid; detection means for detecting whether or not the selenium-containing liquid is in a state where selenium stabilizes at a valence of 4 or higher, based on the measured oxidation-reduction potential and the measured pH value; and addition means for adding bivalent manganese into the selenium-containing liquid when the selenium-containing liquid is in a state where selenium stabilizes at a valence of 4 or higher, wherein bivalent manganese is added into the selenium-containing liquid by the addition means, whereby oxidation of tetravalent selenium to hexavalent selenium is suppressed. In the present invention, whether or not the selenium-containing liquid is in a state where selenium stabilizes at a valence of 4 or higher is detected by the detection means based on the measured oxidation-reduction potential and the measured pH value. When the selenium-containing liquid is in a state in which selenium is stable at a valence of 4 or higher, bivalent manganese is added into the selenium-containing liquid. In this manner, only when tetravalent selenium is likely to be oxidized to hexavalent selenium, bivalent manganese is added to suppress the oxidation of selenium. According to this procedure, the oxidation of tetravalent selenium in the selenium-containing liquid can be suppressed more accurately.

The method for treating a selenium-containing liquid according to the present invention comprises a detection step of measuring an oxidation-reduction potential and a pH value of a selenium-containing liquid, and detecting whether or not the selenium-containing liquid is in a state where selenium stabilizes at a valence of 4 or higher, based on the oxidation-reduction potential and the pH value; and is characterized in that when the selenium-containing liquid is in a state where selenium stabilizes at a valence of 4 or higher, bivalent manganese is added into the selenium-containing liquid, whereby oxidation of tetravalent selenium to hexavalent selenium is suppressed. In the present invention, the detection step is provided for detecting whether or not the selenium-containing liquid is in a state where selenium stabilizes at a valence of 4 or higher, based on the oxidation-reduction potential and the pH value. When the selenium-containing liquid is in a state in which selenium is stable at a valence of 4 or higher, bivalent manganese is added into the selenium-containing liquid. In this manner, only when tetravalent selenium is likely to be oxidized to hexavalent selenium, bivalent manganese is added to suppress the oxidation of selenium. According to this procedure, the oxidation of tetravalent selenium in the selenium-containing liquid can be suppressed more accurately.

Preferably, when the selenium-containing liquid is in a state where selenium stabilizes at a valence of 4 or higher, it is detected in the detection step whether or not the selenium-containing liquid is in a state where manganese stabilizes as manganese dioxide, based on the measured oxidation-reduction potential and the measured pH value, and the method for treating a selenium-containing liquid further comprises a lowering step which, when the selenium-containing liquid is in a state where manganese stabilizes as manganese dioxide, lowers the oxidation-reduction potential of the selenium-containing liquid until the selenium-containing liquid falls into a state where manganese stabilizes as bivalent manganese. By lowering the oxidation-reduction potential until the selenium-containing liquid falls into a state where manganese stabilizes as bivalent manganese, the oxidation of selenium can be suppressed appropriately, with the amount of consumption of bivalent manganese being kept down, when bivalent manganese is added.

In a preferred embodiment of the present invention, when it is detected by the detection step that the selenium-containing liquid is in a state where selenium stabilizes at a valence of 4 or higher, a setting step is performed so as to set a predetermined bivalent manganese concentration based on a concentration of peroxodisulfuric acid and a concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid, and bivalent manganese is added into the selenium-containing liquid such that the selenium-containing liquid has the predetermined bivalent manganese concentration.

Preferably, when the selenium-containing liquid is in a state where selenium stabilizes at a valence of 4 or higher, it is detected in the detection step whether or not the selenium-containing liquid is in a state where manganese stabilizes as manganese dioxide, based on the measured oxidation-reduction potential and the measured pH value, and when the selenium-containing liquid is in a state where manganese stabilizes as manganese dioxide, a higher bivalent manganese concentration than the predetermined bivalent manganese concentration is set in the setting step. The bivalent manganese concentration is set to be higher than the predetermined bivalent manganese concentration. By so doing, bivalent manganese can be added in a larger amount than oxidized with peroxodisulfuric acid. As a result, even in a case where bivalent manganese is oxidized by reaction with an oxidizing substance other than peroxodisulfuric acid, the unreacted remaining bivalent manganese can suppress the oxidation of tetravalent selenium.

### Effects of the Invention

With the system for treating a selenium-containing liquid and the method for treating a selenium-containing liquid according to the present invention, the oxidation of tetravalent selenium in the selenium-containing liquid can be suppressed more accurately. With the wet flue gas desulfurization device of the present invention, the oxidation of tetravalent selenium in the selenium-containing liquid within the wet flue gas desulfurization device can be suppressed more accurately.

### BRIEF DESCRIPTION OF THE DRAWINGS

FIG. 1 is a map showing a pH-potential diagram representing the relation between the pH value and the oxidation-reduction potential used in the detection step of the present invention.

FIG. 2 is a schematic view showing the wet flue gas desulfurization device of the present invention.

### MODE FOR CARRYING OUT THE INVENTION

### (Method for Treating Selenium-Containing Liquid)

The method for treating a selenium-containing liquid according to the present invention will now be described below.

The method for treating a selenium-containing liquid according to the present invention suppresses the oxidation of tetravalent selenium to hexavalent selenium in a selenium-containing liquid such as industrial waste water or waste water from a wet flue gas desulfurization device of a coal-fired power plant.

For example, the behavior of selenium in a desulfurization slurry within a wet flue gas desulfurization device will be explained. In a coal fired power plant, a combustion exhaust gas from a boiler is released to the atmosphere via a denitration device, an electrostatic precipitator, and the wet flue gas desulfurization device. The combustion exhaust gas from the boiler contains gaseous selenium, and the gaseous selenium is passed through the denitration device, the electrostatic precipitator, etc., and introduced into the wet flue gas desulfurization device.

The selenium introduced into the wet flue gas desulfurization device dissolves in the desulfurization slurry (a slurry containing limestone and slaked lime as desulfurizing agents, and gypsum as the product) within the wet flue gas desulfurization device, and exists initially as tetravalent selenium. The wet flue gas desulfurization device is newly supplied with a slurry of limestone and slaked lime as desulfurizing agents and, at the same time, a part of the desulfurization slurry containing gypsum as the product is discharged. Thus, the desulfurization slurry resides for a long time (e.g., 50 hours or so) within the wet flue gas desulfurization device. During its residence within the wet flue gas desulfurization device, tetravalent selenium in the desulfurization slurry is oxidized to hexavalent selenium by reaction with peroxodisulfuric acid which is an oxidizing substance. Tetravalent selenium can be easily treated by a conventional coagulation-sedimentation process, but if oxidized to hexavalent selenium, has posed the problem that the treatment of the hexavalent selenium requires a cost and labor. That is, the hexavalent selenium is reduced to tetravalent selenium or zero-valent metallic selenium with the use of metallic iron as a reducing agent, and the tetravalent selenium or the zero-valent metallic selenium is treated by the coagulation-sedimentation process or the like. This is costly and laborious.

In suppressing the oxidation of tetravalent selenium to hexavalent selenium by adding bivalent manganese, which is easily reactive with peroxodisulfuric acid being an oxidizing substance, to such a selenium-containing liquid, the oxidation-reduction potential and pH value of the selenium-containing liquid are important for adding bivalent manganese with an appropriate timing and in an appropriate amount. The present inventors have discovered this fact.

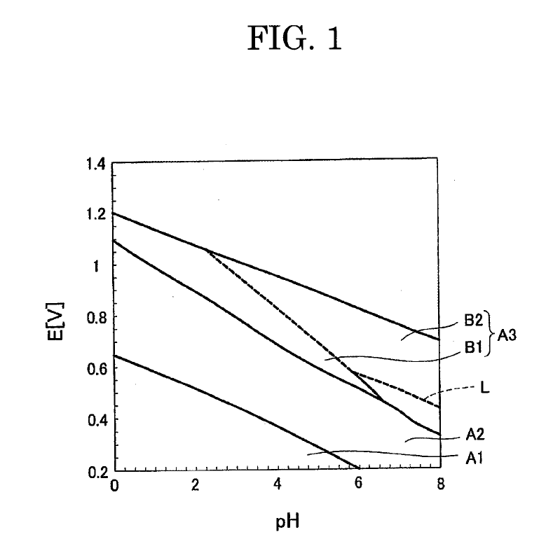

in the present embodiment, the oxidation-reduction potential and pH value of the selenium-containing liquid are measured, and what state the selenium-containing liquid is in is detected based on the relation between the oxidation-reduction potential and the pH value. That is, in the light of the pH-potential diagram shown in the map of FIG. 1 and the oxidation-reduction potential and pH value measured, it is detected what state the selenium-containing liquid is in. This is a detection step. The potential in THE pH-potential diagram of FIG. 1 refers to the standard electrode potential, which can be easily converted from the measured oxidation-reduction potential.

The pH-potential diagram of FIG. 1 shows the state of the selenium-containing liquid in which selenium stabilizes at a valence of 0 (region A1), the state of the selenium-containing liquid in which selenium stabilizes at a valence of 4 (region A2), and the state of the selenium-containing liquid in which selenium stabilizes at a valence of 6 (region A3). In the region A3 representing the state of the selenium-containing liquid in which selenium stabilizes at a valence of 6, moreover, a dashed line L is drawn which defines a boundary between the state of the selenium-containing liquid in which manganese stabilizes when being bivalent manganese (region B1) and the state of the selenium-containing liquid in which manganese stabilizes when being manganese dioxide (region B2). That is, the region A3 is divided into the region B1 and the region B2.

As noted above, the use of the pH-potential diagram shown in FIG. 1 enables the state of the selenium-containing liquid to be detected simply and easily.

By using the pH-potential diagram, the state of the selenium-containing liquid can be detected, and whether or not the addition of bivalent manganese is effective can be detected. First, when the selenium-containing liquid is in a state where selenium is stable at a valence of 0 (region A1), the possibility of tetravalent selenium being oxidized to hexavalent selenium is so low that bivalent manganese need not be added.

When the selenium-containing liquid is in a state where selenium stabilizes at a valence of 4 (region A2), selenium is stable when tetravalent, unless there is an oxidizing substance which oxidizes selenium, such as peroxodisulfuric acid. Thus, it suffices to add bivalent manganese such that a concentration set by a concentration setting step to be described later is reached.

When the selenium-containing liquid is in a state where selenium stabilizes at a valence of 6 and manganese is stable when being bivalent manganese (region B1), tetravalent selenium tends to be oxidized. Upon addition of bivalent manganese, however, manganese stabilizes as bivalent manganese in the selenium-containing liquid. In this state, therefore, bivalent manganese reacts with peroxodisulfuric acid, making it possible to suppress the oxidation of tetravalent selenium. Hence, bivalent manganese is added such that the concentration set by the concentration setting step to be described later is reached.

When the selenium-containing liquid is in a state where selenium stabilizes at a valence of 6 and manganese stabilizes when in the form of manganese dioxide (region B2), tetravalent selenium is apt to be oxidized with peroxodisulfuric acid, and bivalent manganese added is converted into manganese dioxide, so that bivalent manganese may fail to suppress the oxidation of tetravalent selenium.

In this case, the oxidation-reduction potential in the selenium-containing liquid is lowered to achieve the state of the selenium-containing liquid in which manganese stabilizes when in the form of bivalent manganese. Concretely, if the selenium-containing liquid is a slurry in the wet flue gas desulfurization device, for example, the amount of supply of oxidizing air in the wet flue gas desulfurization device is decreased, whereby the slurry enters a state where manganese stabilizes when in the form of bivalent manganese. By increasing the amount of withdrawal of the desulfurization slurry as compared with that during the ordinary operation to replace the slurry, etc., moreover, the oxidation-reduction potential can be lowered. Then, when the selenium-containing liquid falls into a state corresponding to the region B1, bivalent manganese is added such that the concentration set by the concentration setting step to be described later is reached. The addition of bivalent manganese causes no change to the oxidation-reduction potential, etc., because the amount of its addition is minute relative to the selenium-containing liquid as a whole.

Alternatively, in this case, bivalent manganese is added in a larger amount than a predetermined value whose details will be described later in the concentration setting step. By so doing, the oxidation of selenium can be suppressed by the addition of bivalent manganese. That is, bivalent manganese is added so as to achieve a concentration equal to or higher than the concentration of bivalent manganese set by the concentration setting step (to be described later) for preventing the oxidation of tetravalent selenium contained in the selenium-containing liquid. By so doing, bivalent manganese is oxidized to manganese dioxide upon its reaction with an oxidizing substance other than peroxodisulfuric acid, but the oxidation of tetravalent selenium can be suppressed by bivalent manganese left unreacted. Examples of the oxidizing substance other than peroxodisulfuric acid include dissolved oxygen in the selenium-containing liquid and various metal components as reactants.

In this case, in adding bivalent manganese so as to achieve the concentration equal to or higher than the bivalent manganese concentration set by the concentration setting step, it is desirable to add bivalent manganese so as to achieve 5 to 10 times the bivalent manganese concentration set by the concentration setting step, and further to adjust the concentration of addition while confirming the actual amount consumed.

When the selenium-containing liquid is in the state of the region A2 or B1 in the detection step of detecting the state of the selenium-containing liquid by use of the pH-potential diagram as mentioned above, the setting step of setting the amount of bivalent manganese added is performed. The setting step sets the concentration of bivalent manganese that can suppress the oxidation of tetravalent selenium in the selenium-containing liquid at a desired ratio after a lapse of a desired time. In order that this set bivalent manganese concentration can be held, bivalent manganese is added into the selenium-containing liquid (addition step), whereby the oxidation of tetravalent selenium to hexavalent selenium is suppressed at the desired ratio.

Concretely, the setting step comprises a concentration measurement step of measuring the concentration of peroxodisulfuric acid and the concentration of tetravalent selenium in the selenium-containing liquid; the concentration setting step of setting the bivalent manganese concentration based on the concentration of peroxodisulfuric acid and the concentration of tetravalent selenium, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid; and the addition step of adding bivalent manganese to the selenium-containing liquid such that the set bivalent manganese concentration is held in the selenium-containing liquid. For example, the peroxodisulfuric acid (initial) concentration and the tetravalent selenium (initial) concentration in the selenium-containing liquid at 50° C. are measured to obtain 1 mg/L as the tetravalent selenium concentration and 300 mg/L as the peroxodisulfuric acid concentration (concentration measurement step). Based on the reaction rate constant ratio which shows the ratio of the reaction rate constant in the reaction between bivalent manganese and peroxodisulfuric acid to the reaction rate constant in the reaction between tetravalent selenium and peroxodisulfuric acid (the reaction rate constant ratio is 4.27 if the temperature of the selenium-containing liquid is 50° C.), the reaction rate constant in the decomposition reaction of peroxodisulfuric acid (1.2×10⁻⁶ if the temperature of the selenium-containing liquid is 50° C.), the resulting selenium concentration of 1 mg/L, and the resulting peroxodisulfuric acid concentration of 300 mg/L, the bivalent manganese concentration is set at 0.9 mmol/L (concentration setting step), if it is desired to obtain an oxidation ratio of 10% for oxidation to hexavalent selenium 48 hours later. Bivalent manganese is added to the selenium-containing liquid such that the set bivalent manganese concentration is attained (addition step).

Hereinbelow, the concentration setting step will be described concretely.

As described above, the initial concentration of peroxodisulfuric acid and the initial concentration of tetravalent selenium are measured first of all in the concentration measurement step.

Then, the bivalent manganese concentration is set based on the initial concentration of peroxodisulfuric acid and the initial concentration of tetravalent selenium, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid.

Concretely, the tetravalent selenium concentration and the hexavalent selenium concentration at each time are calculated by making arrangements, with the use of a sequential computation method such as Euler's method, based on Equations (4), (5) and (6) below, the initial concentration C_{S2082-,0} of peroxodisulfuric acid and the initial concentration of tetravalent selenium that have been measured, an arbitrary bivalent manganese concentration, the reaction rate constant k₁ in the decomposition reaction (Formula (1)) of peroxodisulfuric acid, and the reaction rate constant ratio k₃/k₂ which is the ratio of the reaction rate constant k₃ in the reaction (Formula (3)) between bivalent manganese and peroxodisulfuric acid to the reaction rate constant k₂ in the reaction (Formula (2)) between tetravalent selenium and peroxodisulfuric acid. In the Equations (4), (5) and (6), r_{SeO32-} represents the reaction rate of tetravalent selenium, r_{Mn2+} represents the reaction rate of bivalent manganese, q_{SeO32-} represents the amount of tetravalent selenium adsorbed to manganese dioxide per gram, and A and B represent, respectively, constants obtained from the relation between ln q_{SeO32-} and ln C_{SeO32-}.

S₂O₈²⁻+e⁻→SO₄⁻+SO₄²⁻ (1)

SeO₃²⁻+2SO₄⁻+H₂O→SeO₄²⁻+2SO₄⁻+2H⁺ (2)

Mn²⁺+2SO₄⁻+2H₂O→MnO₂+2SO₄²⁻+4H⁺ (3)

r_{SeO32-}=dC_{SeO32}/dt=−k₁k₂C_{S2O82-,0}e^{-k1t}C_{SeO32-}/(2k₂C_{SeO32-}+2k₃C_{Mn2+}) (4)

r_{Mn2+}=dC_{Mn2+}/dt=−k₁k₂C_{S2O82-,0}e^{-k1t}C_{Mn2+}/(2k₂C_{SeO32-}+2k₂C_{Mn2+} (5)

ln q_{SeO32-}=ln A+B ln C_{SeO32-} (6)

From the tetravalent selenium concentration and the hexavalent selenium concentration at each time, the oxidation ratio (hexavalent selenium concentration/initial tetravalent selenium concentration) is calculated, and the value of the bivalent manganese concentration when the desired oxidation ratio is reached is set as the bivalent manganese concentration. That is, the bivalent manganese concentration for making the oxidation ratio of tetravalent selenium the desired value is set based on the hexavalent selenium concentration with respect to the initial tetravalent selenium concentration at a desired time t.

The reaction rate constant k₁ in the decomposition reaction of peroxodisulfuric acid, and the reaction rate constant ratio k₃/k₂ are temperature-dependent. Thus, it is permissible to prestore tabular data on the reaction rate constant and the reaction rate constant ratio versus each temperature, and determine the reaction rate constant and the reaction rate constant ratio based on the tabular data.

When the selenium-containing liquid is in the state shown in the region B2 of the pH-potential diagram illustrated in FIG. 1 as described earlier, a higher bivalent manganese concentration than the bivalent manganese concentration set in the concentration setting step is set. Depending on the state of the selenium-containing liquid detected in the detection step, therefore, the bivalent manganese concentration is set to include an amount equal to or larger than the amount of bivalent manganese which is oxidized to manganese dioxide upon reaction with peroxodisulfuric acid.

(Treatment System and Wet Flue Gas Desulfurization Device)

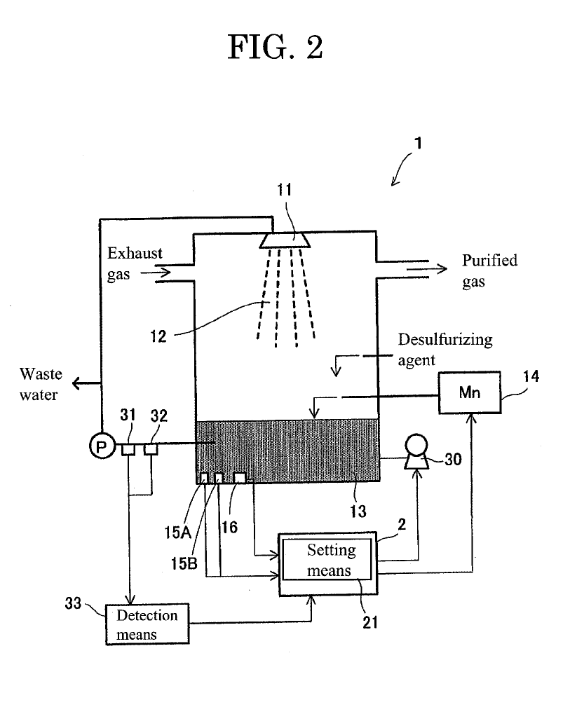

A treatment system for realizing the above-described method for treating the selenium-containing liquid will be explained by reference to FIG. 2.

As shown in FIG. 2, a combustion exhaust gas is introduced into a wet flue gas desulfurization device 1. A desulfurization slurry 12 containing slaked lime, limestone or the like, which serves as a desulfurizing agent, is sprayed into the wet flue gas desulfurization device 1 by a spray means 11 within the wet flue gas desulfurization device 1 to absorb and remove sulfur in the combustion exhaust gas, whereupon a purified gas is discharged. At this time, gaseous selenium contained in the combustion exhaust gas is considered to be incorporated into a desulfurization slurry 13 stored within the wet flue gas desulfurization device 1. Moreover, the slaked lime or limestone in the desulfurization slurry 13 absorbs sulfur to fix it as stable gypsum (calcium sulfate dihydrate CaSO₄.2H₂O). Thus, an oxidation air blower 30 for supplying air for oxidation to the desulfurization slurry 13 is provided. Consequently, the interior of the wet flue gas desulfurization device 1 is brought into a strongly oxidizing atmosphere, and there may be a case where peroxodisulfuric acid is formed. The desulfurization slurry 13 is introduced into the spray means 11 by a circulating pump P, and is circulated within the wet flue gas desulfurization device 1. During circulation, a part of the desulfurization slurry 13 is discharged as flue gas desulfurization waste water.

As seen above, tetravalent selenium and peroxodisulfuric acid are contained in the desulfurization slurry 13. Thus, if the desulfurization slurry 13 resides for a long time within the wet flue gas desulfurization device 1, tetravalent selenium is oxidized to hexavalent selenium. It is preferred to suppress this oxidation and hold a tetravalent selenium state for a long time. In the present embodiment, therefore, bivalent manganese is added to the desulfurization slurry 13, as stated earlier, by a manganese addition means 14. The manganese added by the manganese addition means 14 is added in the state of a bivalent-manganese-containing liquid containing bivalent manganese which reacts with peroxodisulfuric acid. The bivalent-manganese-containing liquid is a solution having a compound of bivalent manganese dissolved therein, or a solution obtained by dissolving zero-valent metallic manganese with an acid or the like.

An oxidation-reduction potential measurement means 31 and a pH value measurement means 32, which are designed to detect such a state of the desulfurization slurry, are provided in the present embodiment. The results of measurements by the oxidation-reduction potential measurement means 31 and the pH value measurement means 32 are inputted to a detection means 33.

Based on the oxidation-reduction potential from the oxidation-reduction potential measurement means 31 and the pH value from the pH value measurement means 32, the detection means 33 detects which state the desulfurization slurry is in, from the pH-potential diagram of the map shown in FIG. 1 which is stored in the detection means 33. The results of detection are inputted to a control means 2. In this case, when the desulfurization slurry is in the state of the region A1, A2 or B1, the control means 2 actuates a setting means 21.

The setting means 21 will be described. In order to determine a bivalent manganese concentration necessary for suppressing the oxidation of tetravalent selenium so that a desired oxidation ratio is attained, the wet flue gas desulfurization device 1 is equipped with a first concentration measurement means 15A for measuring the concentration of peroxodisulfuric acid in the desulfurization slurry 13, and a second concentration measurement means 15B for measuring the concentration of tetravalent selenium in the desulfurization slurry 13. The wet flue gas desulfurization device 1 is also equipped with the setting means 21 for setting a bivalent manganese concentration based on the concentration of peroxodisulfuric acid and the concentration of tetravalent selenium obtained by these measurement means, the reaction rate constant in the decomposition reaction of peroxodisulfuric acid, and the reaction rate constant ratio which is the ratio of the reaction rate constant in the reaction between bivalent manganese and peroxodisulfuric acid to the reaction rate constant in the reaction between tetravalent selenium and peroxodisulfuric acid. The setting means 21 is provided in the control means 2 provided in the wet flue gas desulfurization device 1, and performs the above-described concentration setting step to set the bivalent manganese concentration. In this case, a temperature measurement means 16 for measuring the temperature of the desulfurization slurry 13 is provided within the wet flue gas desulfurization device 1, and a signal indicating the temperature of the desulfurization slurry 13 measured by the temperature measurement means 16 is inputted to the setting means 21. The setting means 21 determines the reaction rate constant ratio based on this temperature, and estimates the amount of tetravalent selenium adsorbed to bivalent manganese to carry out the concentration setting step as described above.

The setting means 21 inputs a signal indicating the set bivalent manganese concentration to the manganese addition means 14. The manganese addition means 14 adds bivalent manganese into the desulfurization slurry 13 such that the bivalent manganese concentration set based on this signal value is reached.

in the present embodiment, as mentioned above, after the state of the selenium-containing liquid is detected, the peroxodisulfuric acid concentration and the tetravalent selenium concentration in the desulfurization slurry 13 can be measured by the first concentration measurement means 15A and the second concentration measurement means 15B, and the bivalent manganese concentration can be set by the setting means 21, so that the desired oxidation ratio is achieved. By this procedure, the desired bivalent manganese can be added where necessary. Thus, tetravalent selenium contained in the desulfurization slurry 13, which is a selenium-containing liquid, can be retained as tetravalent selenium without being oxidized to hexavalent selenium. As a result, the amount of hexavalent selenium is decreased as compared with the conventional procedure. Moreover, the amount of bivalent manganese added can be kept down to a minimum required amount. Thus, selenium in the selenium-containing liquid can be treated, as tetravalent selenium, by a common method such as the coagulation-sedimentation process.

When the desulfurization slurry is in the state of the region B2 according to the results of detection by the detection means 33, the driving state of the oxidation air blower 30 is lowered, for example, so that the desulfurization slurry falls into the state of the region B1 or A2. By so doing, the amount of air in the desulfurization slurry is decreased to lower the oxidation-reduction potential, whereafter bivalent manganese is added such that the bivalent manganese concentration set by the concentration setting step is achieved. Alternatively, with the oxidation-reduction potential not being lowered, the bivalent manganese concentration is set to become higher than the bivalent manganese concentration set by the concentration setting step. By so doing, treatment can be performed similarly.

The method of bringing the combustion exhaust gas and the desulfurization slurry into contact in the wet flue gas desulfurization device is not limited to the spray mode shown in FIG. 2, and may be, for example, a bubbling mode in which the gas is directly introduced into the desulfurization slurry. No matter what mode of vapor-liquid contact is adopted, there is no difference in the desulfurization reaction or in the selenium oxidation reaction. Thus, the present embodiment is not limited in the vapor-liquid contact mode of the wet flue gas desulfurization device.

### EXPLANATIONS OF LETTERS OR NUMERALS

1 Wet flue gas desulfurization device
2 Control means
11 Spray means
12 Desulfurization slurry
13 Desulfurization slurry
14 Manganese addition means
15A First concentration measurement means
15B Second concentration measurement means
16 Temperature measurement means
21 Setting means
31 Oxidation-reduction potential measurement means
32 pH value measurement means
33 Detection means
P Circulating pump

1. A system for treating a selenium-containing liquid by adding bivalent manganese to the selenium-containing liquid, thereby suppressing oxidation of tetravalent selenium to hexavalent selenium, comprising:
potential measurement means for measuring an oxidation-reduction potential of the selenium-containing liquid, and pH measurement means for measuring a pH value of the selenium-containing liquid;
detection means for detecting whether or not the selenium-containing liquid is in a state where selenium stabilizes at a valence of 4 or higher, based on the measured oxidation-reduction potential and the measured pH value; and
addition means for adding bivalent manganese into the selenium-containing liquid when the selenium-containing liquid is in a state where selenium stabilizes at a valence of 4 or higher.

2. The system for treating a selenium-containing liquid according to claim 1, wherein
when detecting that the selenium-containing liquid is in a state where selenium stabilizes at a valence of 4 or higher, based on the measured oxidation-reduction potential and the measured pH value, the detection means detects whether or not the selenium-containing liquid is in a state where manganese stabilizes as manganese dioxide, based on the measured oxidation-reduction potential and the measured pH value, and
the system for treating a selenium-containing liquid further comprises lowering means which, when the selenium-containing liquid is in a state where manganese stabilizes as manganese dioxide, lowers the oxidation-reduction potential of the selenium-containing liquid until the selenium-containing liquid falls into a state where manganese stabilizes as bivalent manganese.

3. The system for treating a selenium-containing liquid according to claim 2, wherein
the addition means includes
first concentration measurement means for measuring a concentration of peroxodisulfuric acid in the selenium-containing liquid;
second concentration measurement means for measuring a concentration of tetravalent selenium in the selenium-containing liquid; and
setting means for setting a predetermined bivalent manganese concentration based on the concentration of peroxodisulfuric acid and the concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid, and
the addition means adds bivalent manganese into the selenium-containing liquid such that the selenium-containing liquid has the predetermined bivalent manganese concentration.

4. The system for treating a selenium-containing liquid according to claim 3, wherein
when detecting that the selenium-containing liquid is in a state where selenium stabilizes at a valence of 4 or higher, the detection means detects whether or not the selenium-containing liquid is in a state where manganese stabilizes as manganese dioxide, based on the measured oxidation-reduction potential and the measured pH value, and
when the selenium-containing liquid is in a state where manganese stabilizes as manganese dioxide, the setting means sets a higher bivalent manganese concentration than the predetermined bivalent manganese concentration.

5. A wet flue gas desulfurization device for removing sulfur oxides in an exhaust gas, comprising:
potential measurement means for measuring an oxidation-reduction potential of a selenium-containing liquid, and pH measurement means for measuring a pH value of the selenium-containing liquid;
detection means for detecting whether or not the selenium-containing liquid is in a state where selenium stabilizes at a valence of 4 or higher, based on the measured oxidation-reduction potential and the measured pH value; and
addition means for adding bivalent manganese into the selenium-containing liquid when the selenium-containing liquid is in a state where selenium stabilizes at a valence of 4 or higher,
wherein bivalent manganese is added into the selenium-containing liquid by the addition means, whereby oxidation of tetravalent selenium to hexavalent selenium is suppressed.

6. A method for treating a selenium-containing liquid, comprising:
a detection step of measuring an oxidation-reduction potential and a pH value of a selenium-containing liquid, and detecting whether or not the selenium-containing liquid is in a state where selenium stabilizes at a valence of 4 or higher, based on the oxidation-reduction potential and the pH value,
wherein when the selenium-containing liquid is in a state where selenium stabilizes at a valence of 4 or higher, bivalent manganese is added into the selenium-containing liquid, whereby oxidation of tetravalent selenium to hexavalent selenium is suppressed.

7. The method for treating a selenium-containing liquid according to claim 6, wherein
in the detection step, when the selenium-containing liquid is in a state where selenium stabilizes at a valence of 4 or higher, it is detected whether or not the selenium-containing liquid is in a state where manganese stabilizes as manganese dioxide, based on the measured oxidation-reduction potential and the measured pH value, and
the method for treating a selenium-containing liquid further comprises a lowering step which, when the selenium-containing liquid is in a state where manganese stabilizes as manganese dioxide, lowers the oxidation-reduction potential of the selenium-containing liquid until the selenium-containing liquid falls into a state where manganese stabilizes as bivalent manganese.

8. The method for treating a selenium-containing liquid according to claim 7, wherein
when it is detected by the detection step that the selenium-containing liquid is in a state where selenium stabilizes at a valence of 4 or higher, a setting step is performed so as to set a predetermined bivalent manganese concentration based on a concentration of peroxodisulfuric acid and a concentration of tetravalent selenium, a reaction rate constant in a decomposition reaction of peroxodisulfuric acid, and a reaction rate constant ratio which is a ratio of a reaction rate constant in a reaction between bivalent manganese and peroxodisulfuric acid to a reaction rate constant in a reaction between tetravalent selenium and peroxodisulfuric acid, and
bivalent manganese is added into the selenium-containing liquid such that the selenium-containing liquid has the predetermined bivalent manganese concentration.

9. The method for treating a selenium-containing liquid according to claim 8, wherein
when the selenium-containing liquid is in a state where selenium stabilizes at a valence of 4 or higher, it is detected in the detection step whether or not the selenium-containing liquid is in a state where manganese stabilizes as manganese dioxide, based on the measured oxidation-reduction potential and the measured pH value, and
when the selenium-containing liquid is in a state where manganese stabilizes as manganese dioxide, a higher bivalent manganese concentration than the predetermined bivalent manganese concentration is set in the setting step.
